(19) United States
(12) Patent Application Publication
(10) Pub. No.: US 2025/0298828 A1
(43) Pub. Date: Sep. 25, 2025

(54) NATURAL LANGUAGE INTERFACE

(71) Applicant: DISH Network Technologies India Private Limited, Bengaluru (IN)

(72) Inventors: Yogesh Malhotra, Bangalore (IN); Praveen Kumar Nadipi Karunakara, Bangalore (IN); Vedam Jude Pragash, Bangalore (IN); Shishir Pandey, Secunderabad (IN)

(21) Appl. No.: 19/085,646

(22) Filed: Mar. 20, 2025

(30) Foreign Application Priority Data
Mar. 20, 2024 (IN) 202441021200

(51) Int. Cl. G06F 16/338; G06F 16/334; G06N 20/00

(52) U.S. Cl. CPC G06F 16/338; G06F 16/3344; G06N 20/00

(57) ABSTRACT

Systems, devices, and methods related to automated management of deployment of applications are provided. An example computer system includes one or more processors and a computer-readable storage media storing computer-executable instructions. The instructions when executed by the one or more processors, cause the computer system to receive a query in natural language from a user, and the query specifies at least one change in resources associated with deployment of an application in a target environment. The instructions when executed by the one or more processors, further cause the computer system to process the query to identify user intent from the query and identify entities related to the at least one change from the query, generate a natural language response to the user query, and output the natural language response to the user. The natural language response includes data associated with the change.

### CROSS REFERENCE TO RELATED APPLICATIONS

This application claims priority to Indian Provisional Patent Application No. 202441021200, titled “AUTOMATED GOVERNANCE AND COMPLIANCE GATING OF APPLICATION DEPLOYMENTS,” filed on Mar. 20, 2024, in the Indian Intellectual Property Office, the disclosure of which is incorporated by reference in its entirety for all purposes. This application is also related to U.S. patent application Ser. No. 18/958,696, filed on Nov. 25, 2024, titled “AUTOMATED GOVERNANCE AND COMPLIANCE GATING OF APPLICATION DEPLOYMENTS,”, U.S. Pat. No. 1,446,931, filed concurrently, titled “AUTOMATED DEPENDENCY MANAGEMENT FOR APPLICATION DEPLOYMENT,”, U.S. Pat. No. 1,446,934, filed concurrently, titled “CHANGE ANALYSIS FOR APPLICATION DEPLOYMENT,” the disclosures of which are incorporated by reference in their entirety for all purposes.

### BACKGROUND

Deployment of a software application typically involves a sequential and multi-stage process, where the software application is released and updated through a step-by-step procedure. Conventional methods for software deployment often follows a linear trajectory, starting with building and development, progressing through validation and testing, and ultimately reaching production deployment. Developers and operations teams are involved in each stage and manage tasks such as code compilation, testing, configuration, and release. A common example of the conventional method is the use of manual deployment scripts or runbooks, where operators execute a series of predefined steps to deploy the software to production servers. However, this conventional method is prone to drawbacks and limitations. Manual interventions can lead to human errors and result in deployment inconsistencies across different environments. In addition, the process tends to be time-consuming and may cause downtime as updates are implemented. Further, the manual deployment process lacks automated decision-making and can hinder agility and scalability.

### BRIEF SUMMARY OF THE DISCLOSURE

The present disclosure provides systems, devices, and methods related to automated management of application deployment. In one example, a computer-implemented method includes receiving, in a natural language interface of a computer system, a query in natural language from a user, and the query specifies at least one change in resources associated with deployment of an application in a target environment. The method further includes processing the query, by the computer system, to identify user intent from the query and identify entities related to the at least one change from the query. The method further includes generating, by the computer system, a natural language response to the user query, and the natural language response includes data associated with the change. The method further includes outputting, by the computer system, the natural language response to the user.

In another example, a computer system includes one or more processors and a computer-readable storage media storing computer-executable instructions, wherein, the instructions when executed by the one or more processors, cause the computer system to perform a method described in the present disclosure.

In accordance with some embodiments, the present disclosure also provides a non-transitory machine-readable storage medium encoded with instructions, the instructions executable to cause one or more electronic processors of a media device to perform any one of the methods described in the present disclosure.

### BRIEF DESCRIPTION OF THE DRAWINGS

FIG. 1 is a block diagram illustrating an example communications system for automated deployment of applications, according to various embodiments of the present disclosure.

FIG. 2A is a block diagram illustrating an example of the communications platform of the communications system of FIG. 1, according to various embodiments of the present disclosure.

FIG. 2B is a block diagram illustrating interactions among the components of the communications platform shown in FIG. 2A as well as interactions between the communications platform of FIG. 2A and components in the communication system shown in FIG. 1, according to various embodiments of the present disclosure.

FIG. 3 is a flow diagram illustrating an example method, according to various embodiments of the present disclosure.

FIG. 4 is a block diagram illustrating an example computer system or computer device, according to various embodiments of the present disclosure.

### DETAILED DESCRIPTION OF THE DISCLOSURE

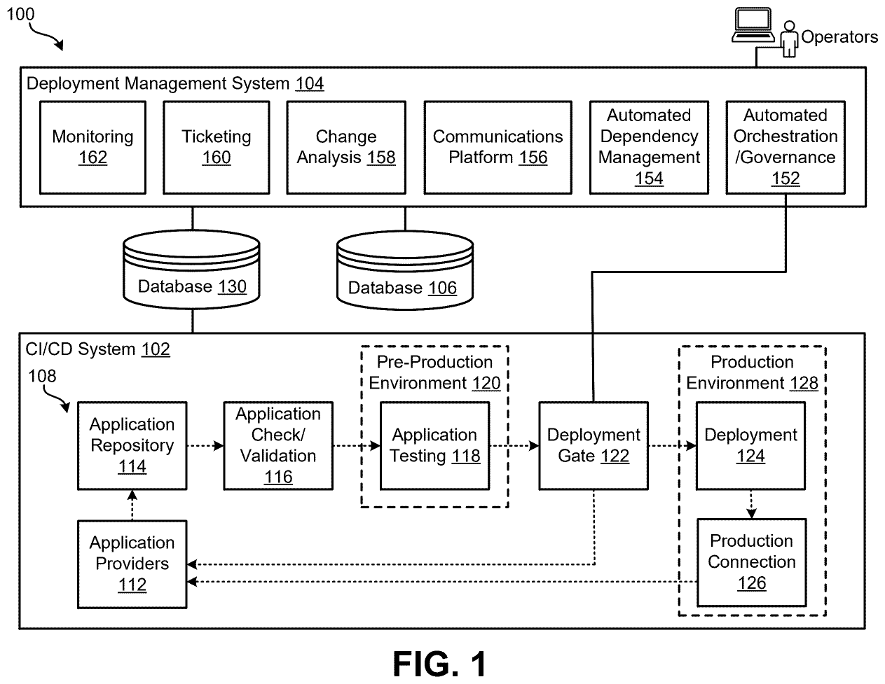

FIG. 1 is a block diagram illustrating an example communications system 100 for deployment of software applications (hereinafter “applications”) in a software application development environment. In the illustrated example, communications system 100 includes, among other components, a continuous integration/continuous deployment system 102 (hereinafter “CI/CD system 102”), a deployment management system 104, and a database 106. Each component included in the communications system 100 may be a hardware component, a software component, or a combination of both hardware and software. Additional or fewer components may be included in the communications system 100. The CI/CD system 102 is generally responsible for deployment of applications through CI/CD pipeline execution. The deployment management system 104 is in communication with the CI/CD system 102 and is operable to allow operators to manage the deployment process of an application through execution of a CI/CD pipeline for the application, monitor the status of CI/CD pipeline execution of a software application, access various application data sources from database 130, determine whether the software application is ready for release, and control block or release of the application through a deployment gate 122 of the CI/CD system. In some embodiments, the deployment management system 104 may be integrated with the CI/CD system 102 to form a single system that includes the components of both.

The CI/CD system 102 further includes, among other components, application providers 112, application inventory 114 (also referred to as “application inventory”), application check and validation system 116, application testing system 118, deployment gate 122, deployment execution system 124, production connections 126, and database 130. Application providers 112 are entities or services that supply the necessary application packages, application artifacts, codes, application configuration data, service applications, docker images, dependencies, or updates of applications to the CI/CD system 102. Application providers 112 may also supply external libraries, third-party components, or internal dependencies for the development and deployment process. In some embodiments, application provider 112 may be an individual software vendor (ISV). In some embodiments, the CI/CD system 102 is automatically triggered to initiate execution of a CI/CD pipeline 108 for deployment of an application upon receiving a request for deploying the application or a request for a change/update/modification to an application.

The application inventory 114 is a centralized storage system where source codes, artifacts, and other relevant files are stored, classified, organized, and maintained. In some embodiments, the application inventory 114 serves as a version-controlled repository and is configured to track, monitor, manage, and update changes to the application codes and make the application codes accessible to the CI/CD system 102 and any components thereof for automated integration and deployment. Version data of the application and any components thereof may be stored in database 130.

The application check validation system 116 is generally responsible for conducting checks, verifications, and validations on the application artifacts before they progress further in the CI/CD pipeline 108. The application check validation system 116 may further include various modules such as code quality assessment module, security scan module, security check module, sentinel check module, dependency check module, environment lock module, metrics and reports module, among others.

For example, the code quality assessment module may be configured to utilize static code analysis tools to evaluate the overall quality of the application artifact according to predetermined standards for maintainability, readability, and adherence to coding standards. The security scan module is configured to conduct security scans on the codebase of the application artifact to identify vulnerabilities, potential exploits, and adherence to security best practices, based on predetermined standards. The security check module is configured to check the security-related aspects of the codebase, including authentication mechanisms, encryption protocols, and secure coding protocols. The sentinel check module is configured to implement automated validation routines or scripts to assess whether the predefined conditions or criteria are met before allowing the application artifacts to proceed further in the CI/CD pipeline 108.

The dependency check module is configured to check and validate dependencies within an application. Dependencies may include external libraries, frameworks, modules, or other components on which the application relies. In some embodiments, the dependency check module is configured to analyze the dependencies declared or utilized by the application, verify the compatibility of the dependencies with a target environment, check whether the dependencies of the application conform to version requirements, check whether the dependencies adhere to licensing requirements and organizational policies, check the overall health of dependencies. The dependency check module may generate output with outcomes of the dependency check. Dependency data of an application is stored in database 130. Directed dependency graphs generated from the dependency data are also stored in database 130.

The environment lock module is generally responsible for managing and enforcing locks on different environments during the deployment process. The environment lock module may be configured to identify different deployment environments, such as development, testing, and production, where application artifacts move through the CI/CD pipeline 108, implement a locking mechanism that can be applied to each environment individually, support time-based locks to allow the definition of specific time intervals during which an environment is locked, and monitors the status of environment locks in real-time. Environment lock data is stored in database 130.

The metrics and reports module is generally responsible for collecting, analyzing, and presenting relevant metrics and reports related to the deployment process through the CI/CD pipeline 108. The metrics and reports module may be configured to collect various data and output reports from other components within CI/CD system 102, define and track metrics that are aligned with predetermined criteria, utilizes automated analysis tools to process the collected data and derive insights, generate and manage reports based on the analyzed metrics, and present metrics and insights in a visually accessible format, such as charts, graphs, and dashboards. Performance metrics data is stored in database 130.

The application testing system 118 is generally responsible for testing the application artifacts in pre-production environment 120 before deployment in the production environment 128. The application testing system 118 may be configured to generate and configure testing environments, executing test instances of the application artifact in the configured testing environments, monitoring the testing, and generating outcome (e.g., testing report). A test environment used herein refers to a controlled and isolated setup that mimics the production environment to conduct application testing and validate the functionality, performance, and reliability of a software application. Execution of test instances includes the execution of a specific set of test cases designed to validate certain aspects of the application, such as functionality, performance, or security. Each test instance may be conducted in isolation to focus on a specific aspect of the application. Input data specific to a test environment may be used to simulate realistic conditions and interactions with the application. Expected outcomes may be determined based on the test case specifications, and the actual outcomes during execution may be compared against the expected outcome to determine whether the application passes the testing. Testing and validation data of an application is stored in database 130.

The deployment gate 122 is the final gate before deploying the application in the production environment 128. The deployment gate 122 is controlled by the deployment management system 104 to verify that the application has undergone required validation and testing, including but not limited to checking the validation status, checking for successful execution of test cases, meeting quality standards, and/or addressing any identified defects or deficiencies. The deployment gate 122 is further configured to execute an instruction to release or block release of the deployment based on determinations whether all predetermined requirements for deployment are met. These requirements may cover functional correctness, performance, security, reliability, and compliance with predetermined or pre-established policies and standards. If the application passes all validation and testing checks, and if all predetermined requirements are met, the deployment gate 122 allows the release of the application to the production environment 128. If any issues are identified during the validation process or if predetermined requirements are not met, the deployment gate 122 holds the release of the application.

In some embodiments, the deployment gate 122 is controlled by the deployment management system 104 to allow or hold the release of the application based on a release readiness score. A release readiness score used herein refers to a quantitative or semi-quantitative measure or numerical representation that assesses the overall readiness of an application release for deployment to a production environment. The release readiness score may be determined through evaluation of various factors, including the outcomes of validation and testing processes, adherence to predefined requirements, and other relevant criteria. The release readiness score may be determined by the deployment management system 104, based on various analytical data such as the outcomes of validation and testing or relevant reports, to calculate the release readiness score. For example, a threshold release readiness score may be established and used as a standard or reference, and only the application with a release readiness score of or above the threshold release readiness score may be released by the deployment gate 122 to the production environment 128.

The deployment execution system 124 is generally responsible for executing deployment instance of the application released to the production environment and exposing the application to production connections 126. The deployment execution system 124 may coordinate with production connections 126 to integrate the deployed application with other systems, services, and components within the production environment 128. The deployment execution system 124 may also configure the production environment 128 (e.g., update configuration files, adjust database settings, etc.) to accommodate the released application. The production environment is established on an infrastructure. In some embodiments, the production environment is established on a cloud-computing platform. The deployment execution system 124 provides various resources, such as infrastructure resources, platform resources, and application resources for deployment of the application.

The database 130 further includes various application data sources related to the to-be-deployed application and the data generated during the CI/CD pipeline execution of the application. For example, the database 130 may include SLI/SLO/SLA data, environment lock data, reliability index data, prime time data, security data, compliance data, and calculated compliance scores, among others. Service Level Indicators (SLIs) are specific metrics that quantify the performance of a service, such as latency, error rate, and throughput. Service Level Objectives (SLOs) are the target values or ranges for these indicators that define the expected level or quality of service performance for the to-be-deployed application. Environment lock data indicates the status of different environments (e.g., development, testing, staging, production) and whether they are currently locked or available for deployments. Reliability index data includes metrics related to the reliability and stability of the application, such as system uptime, failure rates, and mean time to recovery (MTTR). Prime time data includes information about critical periods when deployments are restricted to avoid disruptions, such as times of high user activity from historical analysis and predetermined critical times. Security data includes information from various security scans and assessments and identified vulnerabilities and threats within the application. Compliance data includes information related to regulatory and internal compliance requirements that the application must adhere to. The deployment management system 104 and various modules included therein may access the data from the database 130 and use the data to determine whether the application is ready for release.

In the illustrated example of FIG. 1, the deployment management system 104 may further include, among other components, an automated orchestration and governance system 152, an automated dependency management system 154, a communications platform or hub 156, a change/update analysis system 158, a ticketing system 160, and a deployment monitoring system 162.

At a high level, the automated orchestration and governance system 152 is generally responsible for coordination and control over the release and deployment processes to ensure smooth, reliable, and secure delivery of application. In some embodiments, the automated orchestration and governance system 152 is configured to receive validation and testing outcomes of the application through the CI/CD pipeline 108 and generated by the CI/CD system 102, analyze the validation and testing outcomes, and determine whether the application is ready to release (e.g., calculating the release readiness score). More details of the automated orchestration and governance system 152 is described in U.S. patent application Ser. No. 18/958,696, filed on Nov. 25, 2024, titled “AUTOMATED GOVERNANCE AND COMPLIANCE GATING OF APPLICATION DEPLOYMENTS,” the disclosure of which is incorporated herein by reference in its entirety.

At a high level, the automated dependency management system 154 is generally responsible for identifying changes in components within an application and assessing their impact on the entire application ecosystem, utilizing automated mechanisms to facilitate a dependency management process. In some embodiments, the changes are resource component changes, for example, infrastructure changes, platform changes, or application changes. The changes are not application code changes. More details of the communications platform 156 described in U.S. Pat. No. 1,446,931, filed concurrently, titled “AUTOMATED DEPENDENCY MANAGEMENT FOR APPLICATION DEPLOYMENT,” the disclosure of which is incorporated herein by reference in its entirety.

At a high level, the application change/update analysis system (i.e., change analysis system or change analyzer) 158 is generally responsible for analyzing and providing insights into the changes and updates made to the application and all dependent applications. The change analysis system 158 is generally configured to conduct change impact analysis, change cost analysis, resource optimization, and predictive modeling. The change analysis system 158 may be configured to incorporate advanced features for identifying, validating, and securing modified components within the application slated for deployment, determine the validations and tests required for deployment of a new application or update of an existing application as well as the validations and tests required for all dependent or impacted applications associated with the new application or update of the application. More details of the change analysis system 158 is described U.S. Pat. No. 1,446,934, filed concurrently, titled “CHANGE ANALYSIS FOR APPLICATION DEPLOYMENT,” the disclosure of which is incorporated herein by reference in its entirety.

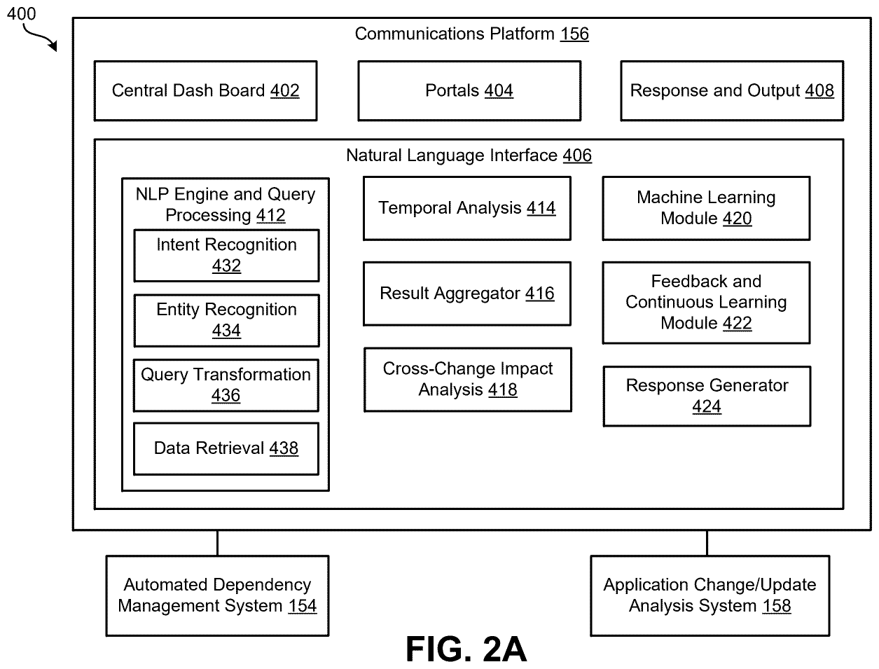

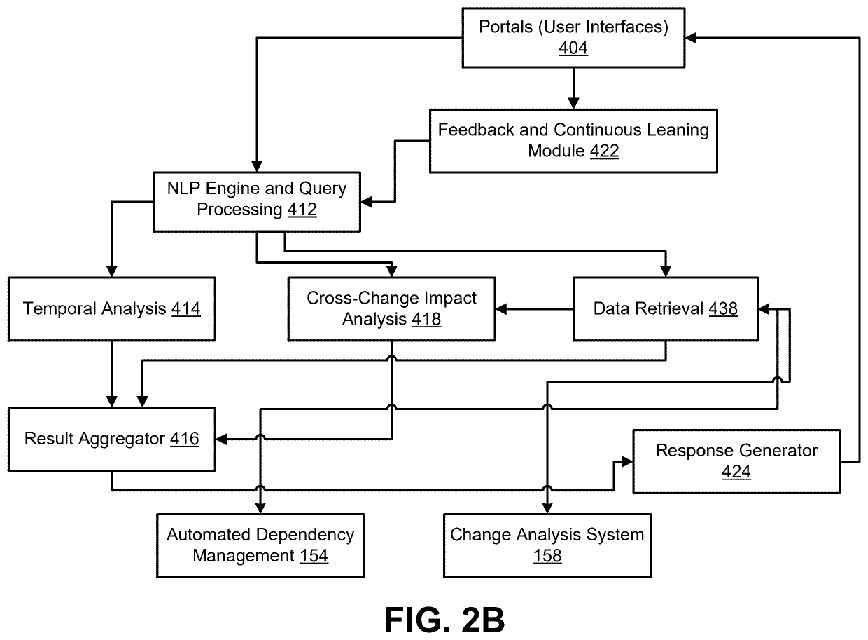

At a high level, the communications platform 156 includes various interfaces for facilitating communications (e.g., message flow, data and file transfer, input, output, etc.) between the deployment management system 104 and the CI/CD system 102 as well as between the deployment management system 104 and operators. The communications platform 156 may include, among others, a natural language interface that provides a platform for the operators to query current and past states of the CI/CD system 102, obtain information about impact analysis of any changes or updates introduced by an application, and set up alerts and create periodic reports. More details of the communications platform 156 is described below with references FIGS. 2A-2B.

At a high level, the ticketing system 160 serves as a central platform and is generally responsible for managing and tracking various activities, requests, incidents and issues related to application changes and deployments. The deployment monitoring system 162 (i.e., monitoring system) is generally responsible for monitoring deployments in real-time and providing immediate visibility into the status and progress of each deployment, detecting errors or issues during the deployment process, generating deployment data (e.g., monitoring/logging/tracing (MELT) data), and tracking resources created for or allocated to the application, tracking dependencies between different components of the application as well as upstream and downstream applications.

The database 106 may include various databases for storing the data received in and generated by the CI/CD system 102 and the deployment management system 104. The database 106 may include a relational database service (RDS) for storing and retrieving structured data where relationships between different resources or data elements need to be maintained, a graph storage or database for storing dependency graph data, a vector database, a MELT database for storing and managing data related to metrics, events, logs, traces related to a specific application or a specific infrastructure, a documentation database for storing and managing code documentation, chaos testing results data, resource cost catalogue storing resource cost data (e.g., predetermined cost of various computing resources), observability and monitoring data, infrastructure documentation, and other relevant information, a reliability database for storing reliability score data for applications, a change analysis data base for change impact data, test case execution result data, risk score data, change cost estimate data, performance change data, among others.

FIG. 2A is a bock diagram illustrating an example of a communications platform 156 shown in FIG. 1. FIG. 2B is a diagram illustrating data flow among various components of the communications platform 156 shown in FIG. 2A. In the illustrated example, the communications platform 156 may be a computer system or a part thereof including various modular components. As illustrated, the communications platform 156 includes a central dashboard 402, portals 404, response and output module 408, and a natural language interface 406. The natural language interface 406 may further include a natural language processing (NLP) and query processing engine 412, a temporal analysis engine 414, a result aggregator 416, a cross-change impact analysis module 418, a machine learning module 420, a feedback and continuous learning module 422, and a response generator 424. The NLP and query processing engine 412 may further include an intent recognition module 432, an entity recognition module 434, a query transformation module 436, and a data retrieval module 438. Fewer or additional modular components may be included in the communications platform 156. The communications platform 156 is in connection with the automated dependency management system 154 and the change analysis system 158. In some embodiments, communications platform 156 is integrated into the automated dependency management system 154 and/or the change analysis system 158 and/or integrated into the automated orchestration and governance system 152.

The central dashboard 402 is as a unified interface that provides users (e.g., operators, administrators, or stakeholders) with real-time status, updates, and data derived from the deployment management system 104 and the components thereof, such as the automated dependency management system 154 and the change analysis system 158. The central dashboard 402 can be configured to display relevant information, such as risk scores, deployment readiness, test results, and coverage metrics, among others. The central dashboard 402 may integrate with other components (e.g., the visualization and reporting engine of the change analysis system 158) to present interactive dependency graphs, impact propagation paths, blast radius diagrams, among others. Through interaction with the central dashboard 402, users can drill down into specific components, such as impacted resources or high-risk nodes, to gain detailed insights. The central dashboard 402 may be configured to timely send a notification or alert to the users about critical issues, such as failed test cases, high-risk scores, or an indication of performance degradations. Alerts may be color-coded and prioritized to highlight urgent items.

The portals 404 may include various API integration portals for facilitating communication between the deployment management system 104 and the external resources. The portals 404 may further include communication channels for facilitating communications between the deployment management system 104 and external APIs and services. In some embodiments, the portals 404 includes security and authentication portals configured to manages security protocols and authentication mechanisms for interactions with external APIs and resources. In some embodiments, the portals 404 provide specific interfaces that allow users to interact with the communications platform 156 based on their specific responsibilities and requirements. For example, an administrator portal allows administrators to configure settings, manage access controls, and monitor overall platform performance, define thresholds for risk scores, configure integration with external systems such as CI/CD pipelines. A developer portal provides developers with tools to query dependency graphs, view change impact analyses, and access test case mappings, submit change requests, review test results, and analyze the potential impact of changes. A QA portal provides QA engineers with access to test case selection and execution workflows, test coverage metrics, and test result summaries. A stakeholder portal provides stakeholders with high-level overviews of changes, such as risk assessments, cost estimates, and performance impact summaries, etc.

The response and output module 408 is responsible for generating and delivering structured and formatted outputs and actionable responses based on the data processed by the communications platform 156. The response and output module 408 is operable to generate reports summarizing analytical results from the change analysis system 158, such as risk assessments, change impact summaries, and test result summaries. The response and output module 408 is operable to send automated notifications to stakeholders based on predefined triggers. For example, the response and output module 408 can notify a deployment operator if a risk score exceeds a predetermined threshold or alert a developer if a change fails a test case. The response and output module 408 can provide recommendations, such as additional test cases to execute, mitigations for high-risk changes, or resources that require further analysis. In some embodiments, the response and output module 408 integrates with CI/CD pipelines, orchestration platforms, and monitoring tools to streamline workflows. For example, the response and output module 408 can trigger automated rollbacks if a change is determined too risky (e.g., the risk score exceeding a predetermined threshold) or update the ticketing system 160 with change analysis results. In some embodiments, the response and output module 408 operates in conjunction with the natural language interface 406 to output responses to user queries. For example, if a user queries for “high-risk changes in the past week,” the response and output module 408 operates to output and present a detailed summary of the relevant changes, associated risks, and identification of the impacted resources.

The NLP and query processing engine 412 allows users to interact with the deployment management system 104 using natural language. The NLP and query processing engine 412 can process user queries (e.g., natural language queries) about changes and impacts, and translate the natural language queries into structured queries on data associated with a change in system components or resources within the target environment to which an application is deployed. Such data may be collected by the automated dependency management system 154 and the change analysis system 158. The NLP and query processing engine 412 can employ various NLP tools and services to understand user intent, extract key entities, and retrieve correct data corresponding to user intent and formulate response in natural language. The NLP and query processing engine 412 can interface with other components within the deployment management system 104 to retrieve relevant data, perform temporal and cross-change impact analysis, and aggregate the results. The NLP and query processing engine 412 can provide explainable, context-aware responses, and translate technical data into user-friendly natural language. The NLP and query processing engine 412 can continuously learn from user interactions to improve accuracy and relevance over time.

In some embodiments, the NLP and query processing engine 412 is operable to parse and understand complex queries about changes and impacts, by employing fine-tuned natural language models (e.g., LLAMA3 or upgraded versions), identify key entities (e.g., services, clusters, and other resources) and their relationships, classify query intent, and determine which other components need to be involved in processing the query. The NLP and query processing engine 412 can employ semantic parsing to break down complex queries into manageable sub-queries, use a combination of rule-based logic and machine learning models (e.g., decision trees) to map intents to specific data retrieval and analysis tasks, and output a structured representation of the query and a detailed execution plan for other components within the deployment management system 104.

Within the NLP and query processing engine 412, the intent recognition module 432 operates to identify a user intent (e.g., “What are the high-risk changes this week?”) and map it to predefined actions, such as risk assessment or change impact analysis. The intent recognition module 432 can employ classification algorithms and LLAMA3-based transformer models fine-tuned for the intent identification. The entity recognition module 434 operates to extract key entities (e.g., “services,” “clusters, “resources,” etc.) and their relationships from user queries. For example, the query “Show me all changes affecting Service A” identifies “Service A” as the key entity. The query transformation module 436 operates to convert natural language queries into structured queries compatible with preestablished data models of the deployment management system 104. For example, a user query can be transformed into a SQL-like query or graph traversal query, according to preestablished data models.

The data retrieval module 438 is an interface for accessing and retrieving data stored in various databases and repositories, such as the graph storage, historical impact database, the test result database, etc. In some embodiments, the data retrieval module 438 interfaces with multiple databases or data repositories included in the automated dependency management system 154 and the change analysis system 158. For example, the data retrieval module 438 retrieves subgraphs from the graph storage to identify dependency relationships and impact pathways related to a specific change. The data retrieval module 438 can access historical impact data, such as past change summaries and risk scores, from the historical impact database to support historical trend analysis. The data retrieval module 438 can also integrate with external monitoring systems to retrieve time-series performance metrics data (e.g., MELT data) for performance analysis.

The data retrieval module 438 can employ query optimization techniques to decompose complex queries into smaller sub-queries that are executed in parallel across multiple data sources, employ indexing algorithms to generate graph-based or temporal indices, and employ cost-based query planning to evaluate multiple execution plans (e.g., selecting the one with the lowest estimated resource usage and response time). For example, the data retrieval module 438 can retrieve pre-indexed centrality metrics and SCC data, upon receiving a query analyzing the propagation speed of a recent change, before executing the full query.

The data retrieval module 438 can implement mechanisms for verifying the accuracy and freshness of retrieved data. For example, the data retrieval module 438 can cross-verify dependency graph updates with corresponding historical impact records. Any inconsistencies between data sources are resolved by prioritizing the most recent or authoritative source. In some embodiments, the data retrieval module 438 can employ real-time synchronization mechanisms to periodically update cached data.

The data retrieval module 438 can implement intelligent caching mechanisms. For example, frequently accessed data, such as recent changes or high-risk resource information, can be pre-cached for rapid retrieval. The caching mechanisms can be dynamically adjusted based on query frequency and user interaction patterns, as identified by the feedback and continuous learning module 422. For example, the data retrieval module 438 can employ time-partitioned caching to store data for specific intervals (e.g., last 24 hours). Automatic cache invalidation policies can be used to replace stale data with updated information.

In some embodiments, the data retrieval module 438 employs time-partitioned data access mechanism to retrieve data in segmented time slices (e.g., hourly or daily) to process queries involving temporal analysis, such as before-and-after comparisons of system metrics. In some embodiments, the data retrieval module 438 can use temporal indexing to locate data for specific time ranges.

The temporal analysis engine 414 is operable to analyze time-based aspects of changes and performance. The temporal analysis engine 414 can employ time-series analysis tools to identify trends, detect anomalies, perform before-and-after comparisons of performance metrics, and establish temporal correlations between changes and the impacts and between the changes in resources and the changes in performance metrics. Trends used herein refer to persistent patterns or directional changes in performance metrics over a period of time, such as a linear increase in CPU utilization over a period of time, a recurring pattern in network traffic corresponding to peak user activity hours, a gradual decline in database query performance indicating degradation over time, etc. Anomalies used herein refer to deviations from expected performance metrics or predetermined standard performance metrics, such as a sudden spike in memory usage not aligned with historical patterns, a drop in API response times outside the normal operating range, unusual fluctuations in network latency during off-peak hours, etc.

In some embodiments, the temporal analysis engine 414 can perform time-series data analysis by processing MELT data collected from monitoring tools and observability platforms. The time-series data can be segmented into time slices. Models such as ARIMA (Auto-Regressive Integrated Moving Average) and Prophet can be employed to determine trends and identify deviations from expected patterns. For example, the temporal analysis engine 414 can predict a potential resource bottleneck by identifying a steady increase in CPU usage over the past 30 days.

The temporal analysis engine 414 is further operable to perform trend and anomaly detection, identify long-term trends in system performance or stability, and flag abnormal deviations caused by changes. In some embodiments, the temporal analysis engine 414 can employ machine learning models such as isolation forests to detect anomalies, such as sudden spikes in resource usage or unexpected latency increases. For example, the temporal analysis engine 414 may detect a 50% increase in query latency and correlate it with an identified update.

In some embodiments, the temporal analysis engine 414 is operable to perform before-and-after comparisons, which evaluate the impact of changes on system metrics by analyzing behavior before and after a change. For example, the temporal analysis engine 414 may employ change point detection algorithms to pinpoint the exact moment when a change began to impact resources and performances. The temporal analysis engine 414 can use statistical hypothesis testing to determine whether observed differences in performance metrics are statistically significant. For example, after a microservice deployment, the temporal analysis engine 414 may compare response times from the 24 hours before and after the deployment to identify an increase or decrease in response times.

The temporal analysis engine 414 is also operable to perform temporal correlation identification, link changes to observed impacts, analyze correlations between metrics and timestamped changes, and identify cascading effects caused by interdependent changes. For example, the temporal analysis engine 414 may determine that a 10% increase in API latency occurred two hours after a database schema change and was amplified by a simultaneous configuration change of load balancer.

The temporal analysis engine 414 can interface with other components, including the cross-change impact analysis module 418, to provide temporal context for cumulative impact assessments. The temporal analysis engine 414 can also integrate with the result aggregator 416 to incorporate time-based insights into user-facing responses and with the response generator 424 generate and present graphical representations of trends, anomalies, and impact timelines.

The cross-change impact analysis module 418 is operable to analyze and synthesize data from multiple changes to uncover correlations, causal relationships, and impacts that may not be apparent when individual changes are analyzed in isolation. The cross-change impact analysis module 418 can ingest input from the automated dependency management system 154 and the change analysis system 158, as well as specific user queries from the NLP and query processing engine 412, to provide insights into the interactions and cumulative effects of changes.

In some embodiments, the cross-change impact analysis module 418 is operable to perform change correlation analysis to identify patterns and relationships between different changes. The cross-change impact analysis module 418 can analyze the interdependencies between the changes and detect connections between changes that may influence one another. For example, the cross-change impact analysis module 418 can employ statistical tools and graph-based algorithms to create a correlation matrix and map interdependencies between components.

In some embodiments, the cross-change impact analysis module 418 is operable to execute temporal impact analysis to examine how multiple changes affect performance, stability, and resource utilization over time. For example, the cross-change impact analysis module 418 can use time-series data retrieved from the temporal analysis engine 414 to assess the cumulative effects of changes and identify trends, such as gradual performance degradation or resource exhaustion caused by a sequence of updates.

In some embodiments, the cross-change impact analysis module 418 can employ causality inference mechanisms to determine whether specific changes are responsible for observed system behaviors or performance shifts. For example, the cross-change impact analysis module 418 may model probabilistic relationships between changes and their effects and employ causal discovery algorithms to distinguish causal relationships from mere correlations. For example, the cross-change impact analysis module 418 may confirm that a 30% drop in application throughput was caused by a recent load balancer reconfiguration and rule out concurrent changes as contributing factors.

The cross-change impact analysis module 418 can also perform cumulative impact assessment and evaluate the aggregate effects of multiple changes on overall system behavior. The cross-change impact analysis module 418 can aggregate risk scores, performance metrics, and impact data from related changes and generate a cumulative impact matrix that quantifies the broader implications of multiple changes. For example, the cross-change impact analysis module 418 may determine that five changes to a microservice may collectively contribute to a 40% increase in resource utilization.

The cross-change impact analysis module 418 is further operable to model change interactions, and identify cases where changes amplify or mitigate the effects of each other. For example, the cross-change impact analysis module 418 may determine that a database update mitigated the negative impact of an API upgrade by reducing query volume.

The cross-change impact analysis module 418 can employ a range of analytical tools and machine learning models, including but not limited to time-series analysis for detecting trends and anomalies, graph-based algorithms for tracing impact pathways, Bayesian networks for probabilistic modeling, and causal discovery algorithms for inferring causal relationships. The cross-change impact analysis module 418 can generate outputs such as correlation matrices, causal graphs, and cumulative impact metrics. The outputs are passed to the result aggregator 416, where they are synthesized into actionable insights for users.

The result aggregator 416 is configured to integrate, reconcile, and prioritize data from multiple sources into a unified, explainable response. In some embodiments, the result aggregator 416 operates to perform data synthesis by gathering information from various components, including the automated dependency management system 154 and the change analysis system 158, temporal analysis engine 414, and cross-change impact analysis module 418. The result aggregator 416 can employ various data fusion algorithms to combine diverse data types, such as risk scores, impact metrics, performance trends, and time-series data, into a structured format, and align data from different timeframes and sources. For example, when a user queries “What are the top risks for the latest deployment?” the result aggregator 416 can synthesize risk scores, performance metrics, and cumulative impact data from multiple sources to generate a coherent summary.

In some embodiments, the result aggregator 416 is operable to resolve data conflicts when discrepancies arise from multiple sources. For example, the result aggregator 416 can apply predefined priority rules to give precedence to more reliable or recent data. The result aggregator 416 can employ explainable AI (XAI) techniques, such as SHAP (SHapley Additive Explanations) values, to evaluate the contributions of conflicting data points to the final result. For example, if one source reports a high risk score while another reports a medium score, the aggregator reconciles the values and provides an explanation for the final decision and the factors influencing the outcome.

The result aggregator 416 is operable to identify and prioritize factors contributing to specific results, such as changes in centrality measures, high-risk nodes, or detected anomalies. In some embodiments, the result aggregator 416 can employ explainable AI tools to provide explanations and insights. For example, when presenting a risk score, the result aggregator 416 can explain that it was influenced by high centrality measures for a critical resource and a 30% increase in response time following a recent deployment.

The result aggregator 416 can also employ multi-criteria decision-making algorithms to prioritize information based on importance to the query. Each data point is scored based on its relevance, reliability, and alignment with the query intent, as determined by the NLP and query processing engine 412. For example, for a query about “system performance after the last change,” the result aggregator 416 can prioritize performance metrics and anomaly detections while de-emphasizing unrelated historical risk data.

The result aggregator 416 can generate a final output including a structured data object containing synthesized information, prioritized insights, and explanations of the results. For example, in response to a query about deployment risks, the result aggregator 416 may generate a ranked list of top risks, explanations for each, and a performance timeline showing pre- and post-change metrics.

In some embodiments, the result aggregator 416 operates to receive structured queries and data from the NLP and query processing engine 412, incorporate correlations and cumulative impacts from the cross-change impact analysis module 418, integrate time-based insights from the temporal analysis engine 414, process the data to generate a report with explanation, and pass the report to the response generator 424, which converts the report into a natural language response for the user.

The response generator 424 is configured to translate structured data into natural language responses to user queries. In some embodiments, the response generator 424 is operable to perform natural language response generation by processing structured data provided by the result aggregator 416 into coherent and contextually relevant text. The response generator 424 can employ fine-tuned transformer-based language models (e.g., LLAMA3 or upgraded versions) trained on domain-specific data, to produce textual outputs. The language models can be trained such that the response generator 424 can handle technical terminology, complex relationships between components, and nuanced query contexts. For example, in response to a user query such as “What are the top risks for the latest deployment?”, the response generator 424 produces a response that summarizes risk scores, the underlying causes, and their potential impacts on system performance, in natural language.

The response generator 424 can also support response formatting and organize outputs into formats such as structured tables, bullet-pointed lists, or hybrid text-and-data summaries. For example, a query regarding impacted resources may result in a table listing each resource, the dependency relationships, and the nature of the impact, while a query about dependency paths may generate a hierarchical list of interconnected nodes. The response generator 424 can employ sequence-to-sequence learning algorithms to map structured input data, such as dependency graphs, to logically structured natural language responses.

The feedback and continuous learning module 422 is configured to enhance and adapt the performance of the NLP and query processing engine 412 and other associated components over time. In some embodiments, the feedback and continuous learning module 422 is operable to collect both explicit and implicit feedback to assess the performance and identify areas for refinement. Explicit feedback includes ratings, comments, and suggestions provided directly by users, such as feedback on the accuracy or relevance of a response. Implicit feedback is derived from user interaction patterns, such as query modifications, abandonment rates, and time spent reviewing results, which provide insights into user satisfaction and system usability. For example, if users frequently abandon queries related to a specific service, the feedback and continuous learning module 422 may log this behavior as a potential issue requiring further analysis.

The feedback and continuous learning module 422 can analyze the collected feedback and usage data to identify trends, anomalies, and opportunities for improvement. For example, the feedback and continuous learning module 422 can employ sentiment analysis tools to interpret user comments and categorize the comments as positive, neutral, or negative. The feedback and continuous learning module 422 can employ anomaly detection algorithms, such as Isolation Forests, to identify unusual usage patterns, such as a sudden spike in queries about a particular service, which may indicate a gap in data retrieval or query interpretation.

The feedback and continuous learning module 422 can employ active learning techniques to prioritize the most informative examples for model updating. The feedback and continuous learning module 422 can apply small adjustments to the machine learning models used by the deployment management system 104, based on incremental feedback and conduct retraining of the machine learning models periodically using curated datasets. For example, if the feedback and continuous learning module 422 identifies repeated failures in interpreting queries about “dependencies for Service B,” it can update the models used by the intent recognition module 432 with additional training examples derived from the feedback.

In some embodiments, the feedback and continuous learning module 422 is operable to manage model versioning, and assign a unique identifier to each model along with metadata describing the changes and the training data used. Model versioning facilitates rollback capability in cases where a model update negatively impacts performance. For example, if a new model version deployed to improve query classification for “resource costs” leads to degraded user satisfaction, the feedback and continuous learning module 422 can revert to the previous version while investigating and resolving the issue.

The feedback and continuous learning module 422 can generate outputs including updated model weights, model versioning updates, new training data, etc. The feedback and continuous learning module 422 can also generate performance metrics to track improvements and maintain transparency across versions.

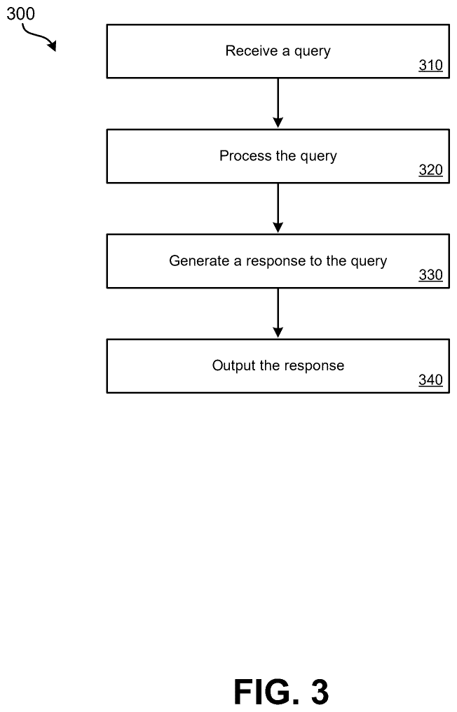

FIG. 3 is a flow diagram illustrating an example method 300 for processing user queries. Method 300 can be a computer-implemented method performed by the communications platform 156 or any components thereof according to FIGS. 2A and 2B. Method 300 includes process blocks 310-340. Fewer or additional process blocks may be included.

At 310, a user query is received in the communications platform and the natural language interface. The query is in natural language and specifies at least one change in resources associated with deployment of an application in a target environment.

At 320, the user query is processed by the natural language interface. In some implementations, a fine-tuned transformer-based language model is employed to identify user intent through classification algorithms and recognize key entities and relationships, such as services, clusters, and resources mentioned in the natural language query. In some implementations, the user query is converted into a structured query that conforms to a preestablished data model. The structured query may be a declarative query (e.g., a SQL-like query) for retrieving tabular data, a graph traversal query for exploring dependency relationships of a dependency graph associated with deployment of the application, and a time-series query for analyzing performance metrics over a specified time range.

In some implementations, data is received in the natural language interface. The data is associated with the structured query from at least one database in connection with the computer system. The data associated with the structured query is analyzed by the natural language interface to identify the at least one change in resources associated with the deployment of the application and change impact associated with the at least one change, identify presence or absence of an anomaly, identify trends in performance metrics, and perform comparisons on performance metrics before and after the change. In some implementations, the user query is decomposed into sub-queries for parallel execution across multiple databases. In some implementations, the dependency graph is indexed to generate graph-based indices for dependency relationships and temporal indices for time-series data. In some implementations, the data associated with the structured query is segmented into temporal slices, and temporal correlations between the at least one change and the change impact are determined based on the time slices. In some implementations, frequently accessed data is pre-cached and dynamically adjusted based on query frequency and user interaction patterns.

In some implementations, the at least one change in resources comprises a plurality of changes. Correlations and interdependencies between the plurality of changes are identified, a cumulative impact caused by the plurality of changes is determined, and causal relationships between the plurality of changes in resources and the performance metrics are determined.

In some implementations, when conflicting data associated with the structured query is received from multiple databases, predefined priority rules are applied to favor the most recent or reliable data sources, and explainable artificial intelligence (AI) tools are employed to explain how conflicting data points are reconciled and contribute to the final result.

At 330, a natural language response to the query is generated by the natural language interface. In some implementations, data points are scored based on relevance, reliability, and alignment with the intent extracted from the user query, and a structured data object containing prioritized insights, explanations, and synthesized information is generated to be included in the natural language response.

At 340, the natural language response is output via the natural language interface, the natural language response is formatted into user-accessible outputs. The outputs may include at least one of: structured tables summarizing metrics or comparisons for query results, bullet-pointed lists describing dependencies, impact pathways, or sequential changes, and hybrid text-and-data formats incorporating graphical descriptions of trends, anomalies, or dependency relationships. In some implementations, sequence-to-sequence learning algorithms may be employed to convert structured data, including dependency graphs and impact metrics, into contextually relevant natural language responses tailored to the intent extracted from the user query and context.

In some implementations, method 300 further includes collecting feedback from users. The feedback includes explicit feedback such as user-provided ratings and comments and implicit feedback derived from user interaction patterns, such as query modifications, abandonment rates, and time spent reviewing results. Method 300 may further include analyzing the feedback using sentiment analysis and anomaly detection to identify one or more machine learning models employed by the natural language interface, and updating the machine learning models according to the user feedback. In some implementations, an identifier is assigned to each one of the machine learning models. A version number is assigned to the machine learning model before and after updating, and the version number indicating metadata describes training datasets used for training the machine learning model. The performance metrics are tracked for each one of the machine learning models. A rollback mechanism is initiated after updating the machine learning model upon a determination of performance degradation caused by the updated machine learning model. In some implementations, periodic retraining of the machine learning models is performed using curated datasets derived from user feedback, and the updated models are validated.

In some implementations, A/B testing can be employed for validation of machine learning models. The A/B testing includes comparison of the performance of an existing model (control group) and an updated model (treatment group). For example, incoming user queries can be assigned to either the control model or the treatment model. Performance metrics, such as accuracy, query resolution time, and user satisfaction scores, are collected for both groups during the test period. The collected metrics are collected and analyzed, for example, using statistical methods, to determine whether the treatment model demonstrates a statistically significant improvement over the control model. If the results indicate superior performance by the treatment model, the updated model is validated.

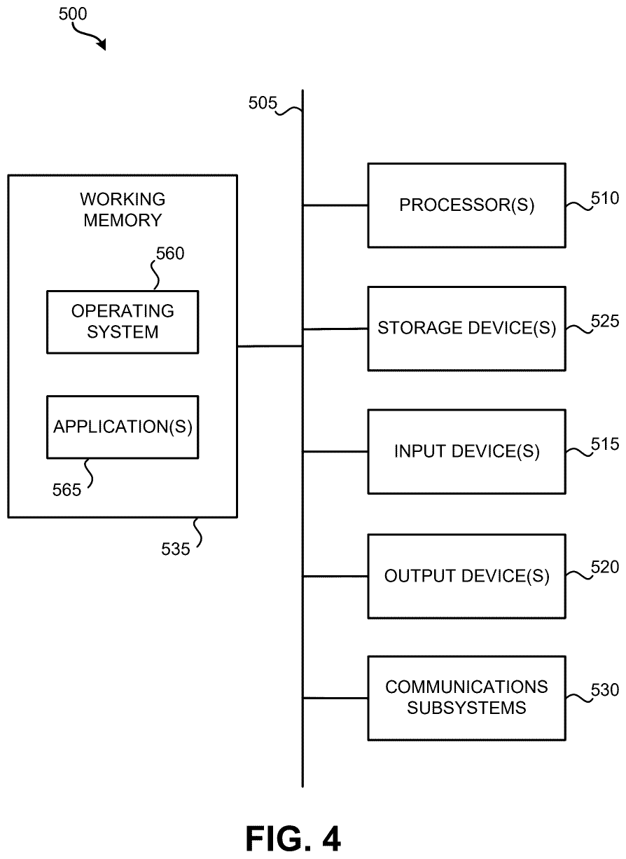

The communications system 100 or any components thereof, such as communications platform 156 as described above, may include a computer system that further includes computer hardware and software that form special-purpose network circuitry to implement various embodiments such as communication, generation of data, determination, identification, calculation, performing a process or other process blocks of the methods described herein. FIG. 4 is a schematic diagram illustrating an example of computer system 500. The computer system 500 is a simplified computer system that can be used to implement various embodiments described and illustrated herein. FIG. 4 provides a schematic illustration of one embodiment of a computer system 500 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 500 is shown including hardware elements that can be electrically coupled via a bus 505, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in one embodiment, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, and the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. In one embodiment, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, or any other magnetic medium, a CD-ROM, any other optical medium, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may, in one embodiment, be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Various aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a test case” includes a plurality of such test cases, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method comprising:
receiving, in a natural language interface of a computer system, a query in natural language from a user, the query specifying at least one change in resources associated with deployment of an application in a target environment;
processing the query, by the natural language interface, to:
identify user intent from the query; and
identify entities related to the at least one change from the query;
generating, by the natural language interface, a natural language response to the user query, the natural language response including data associated with the change; and
outputting, by the natural language interface, the natural language response to the user.

2. The method of claim 1, further comprising:
converting the natural language query into a structured query that conforms to a preestablished data model, the structured query including at least one of:
a declarative query for retrieving tabular data;
a graph traversal query for exploring dependency relationships; and
a time-series query for analyzing performance metrics over a specified time range.

3. The method of claim 2, further comprising:
retrieving, by the natural language interface, data associated with the structured query from at least one database in connection with the computer system, the at least one database being selected from a graph storage containing a dependency graph associated with the deployment of the application, a historical impact database containing historical change data, and a monitoring database containing performance metrics data.

4. The method of claim 3, further comprising:
analyzing, by the natural language interface, the data associated with the structured query to:
identify the at least one change in resources associated with the deployment of the application and change impact associated with the at least one change;
identify presence or absence of an anomaly; and
perform comparisons on performance metrics before and after the change.

5. The method of claim 4, wherein the further comprising:
segmenting the data associated with the structured query into time slices; and
determining temporal correlations between the at least one change and the change impact based on the time slices.

6. The method of claim 4, wherein the at least one change in resources comprises a plurality of changes, and the method further comprises:
identifying correlations and interdependencies between the plurality of changes; and
determining a cumulative impact caused the plurality of changes.

7. The method of claim 6, wherein the at least one change comprises a plurality of changes, and the method further comprises:
determining causal relationships between the plurality of changes in resources and the performance metrics.

8. The method of claim 2, further comprising:
receiving, in the natural language interface, feedback from users;
analyzing, by the natural language interface, the feedback to identify one or more machine learning models employed by the natural language interface; and
updating the identified machine learning models.

9. The method of claim 8, wherein updating the identified machine learning models further comprises:
assigning an identifier to each one of the machine learning models;
assigning a version number to the machine learning model before and after updating, the version number indicating metadata describing training datasets used for training the machine learning model; and
tracking the performance metrics for each one of the machine learning models.

10. The method of claim 9, wherein updating the identified machine learning models further comprises:
initiating rollback after updating the machine learning model upon a determination of performance degradation caused by the updated machine learning model.

11. A computer system comprising:
one or more processors; and
a computer-readable storage media storing computer-executable instructions, wherein, the instructions when executed by the one or more processors, cause the computer system to:
receive a query in natural language from a user, the query specifying at least one change in resources associated with deployment of an application in a target environment;
process the query to:
identify user intent from the query; and
identify entities related to the at least one change from the query;
generate a natural language response to the user query, the natural 12 language response including data associated with the change; and
output the natural language response to the user.

12. The computer system of claim 11, wherein the instructions when executed by the one or more processors further cause the computer system to:
convert the natural language query into a structured query that conforms to a preestablished data model, the structured query including at least one of:
a declarative query for retrieving tabular data;
a graph traversal query for exploring dependency relationships; and
a time-series query for analyzing performance metrics over a specified time range.

13. The computer system of claim 12, wherein the instructions when executed by the one or more processors further cause the computer system to:
retrieve data associated with the structured query from at least one database in connection with the computer system, the at least one database being selected from:
a graph storage containing a dependency graph associated with the deployment of the application;
a historical impact database containing historical change data; and
a monitoring database containing performance metrics data.

14. The computer system of claim 13, wherein the instructions when executed by the one or more processors further cause the computer system to:
analyze the data associated with the structured query to:
identify the at least one change in resources associated with the deployment of the application and change impact associated with the at least one change;
identify presence or absence of an anomaly; and
perform comparisons on performance metrics before and after the change.

15. The computer system of claim 14, wherein the instructions when executed by the one or more processors further cause the computer system to:
segment the data associated with the structured query into time slices; and
determine temporal correlations between the at least one change and the change impact based on the time slices.

16. The computer system of claim 14, wherein the at least one change comprises a plurality of changes, and the instructions when executed by the one or more processors further cause the computer system to:
identify correlations and interdependencies between the plurality of changes; and
determine a cumulative impact caused the plurality of changes.

17. The computer system of claim 16, wherein the instructions when executed by the one or more processors further cause the computer system to:
determine causal relationships between the plurality of changes in resources and the performance metrics.

18. The computer system of claim 12, wherein the instructions when executed by the one or more processors further cause the computer system to:
receive feedback from users;
analyzing the feedback to identify one or more machine learning models employed by the natural language interface; and
update the identified machine learning models.

19. The computer system of claim 18, wherein the instructions when executed by the one or more processors further cause the computer system to:
assign an identifier to each one of the machine learning models;
assign a version number to the machine learning model before and after updating, the version number indicating metadata describing training datasets used for training the machine learning model; and
track the performance metrics for each one of the machine learning models.

20. The computer system of claim 19, wherein the instructions when executed by the one or more processors further cause the computer system to:
initiate rollback after updating the machine learning model upon a determination of performance degradation caused by the updated machine learning model.
